(19) United States
(12) Patent Application Publication
(10) Pub. No.: US 2026/0321588 A1
(43) Pub. Date: Oct. 15, 2026

(54) SECONDARY BATTERY

(71) Applicant: Panasonic Energy Co., Ltd., Moriguchi-shi, Osaka (JP)

(72) Inventor: Shigeki Moriya, OSAKA FU (JP)

(73) Assignee: Panasonic Energy Co., Ltd., Moriguchi-shi, Osaka (JP)

(21) Appl. No.: 18/998,690

(22) PCT Filed: Jun. 2, 2023
(86) PCT No.: PCT/JP2023/020600

§ 371 Date: Jan. 27, 2025

(30) Foreign Application Priority Data
Jul. 29, 2022 (JP) 2022-122114

(51) Int. Cl. H01M 4/36; H01M 4/02; H01M 4/58; H01M 10/0525

(52) U.S. Cl. CPC H01M 4/364; H01M 4/366; H01M 4/5825; H01M 2004/021; H01M 2004/027; H01M 10/0525

(57) ABSTRACT

A first negative electrode active material including a Li-doped first silicon oxide phase with dispersed silicon phases, and a second negative electrode active material including a Mg-doped second silicon oxide phase with dispersed second silicon phases. A film thickness of a negative electrode active material layer being T, a region of the negative electrode active material layer ranging in depth from the first surface to 0.5T is a lower layer portion, and a region of the negative electrode active material layer ranging in depth from the second surface to 0.5T is an upper layer portion, a content ratio Cb on a mass basis of the first negative electrode active material to the sum of the first and second negative electrode active materials in the lower layer portion is larger than a content ratio Ct in the upper layer portion.

### TECHNICAL FIELD

The present disclosure relates to a secondary battery.

### BACKGROUND ART

Secondary batteries, particularly lithium-ion secondary batteries, have high power output and high energy density, and are therefore expected as power sources for small consumer applications, power storage devices, and electric vehicles. Among them, in secondary batteries used as power sources for driving, for example, electric vehicles (EV) and hybrid electric vehicles (HEV and PHEV) and power sources for electronic devices, it is required to be able to supply more electric power to the devices more quickly.

In response to the demand for high energy density batteries, a material containing silicon that can make an alloy with lithium, such as SiOx, is expected to be used as a negative electrode active material having a high theoretical capacity density.

The material containing silicon has a low initial efficiency (ratio of discharge capacity to charge capacity in initial charge and discharge). From the point of view of the above, it is proposed to form in advance a lithium compound or a magnesium compound which does not contribute to charge and discharge, by pre-doping Li or Mg in a silicon-containing material (see, for example, Patent Literatures 1 and 2). Li or Mg doping reduces generation of a lithium compound that does not contribute to charge and discharge during charging, to inhibit occurrence of irreversible capacity loss.

### CITATION LIST

### Patent Literature

Patent Literature 1: Japanese Patent No. 5411781
Patent Literature 2: Japanese Laid-Open Patent Publication No. 2017-204374

### SUMMARY OF INVENTION

### Technical Problem

Since a magnesium compound generated with Mg-doped SiOx has a larger lattice constant than that with Li-doped SiOx, using Mg-doped SiOx, a secondary battery that has higher lithium ion conductivity and more excellent power output characteristics (e.g., rapid charge and discharge characteristics) can be obtained. However, due to Mg being heavier than Li, the capacity per mass of the secondary battery is reduced. In view of increasing the capacity per mass, it is preferable to use Li-doped SiOx rather than Mg-doped SiOx.

### Solution to Problem

In view of the above, one aspect of the present disclosure relates to a secondary battery including: a positive electrode; a negative electrode; and an electrolyte, wherein the negative electrode includes a negative electrode current collector and a negative electrode active material layer provided on the negative electrode current collector, the negative electrode active material layer contains a first negative electrode active material and a second negative electrode active material, the first negative electrode active material includes a first silicon oxide phase doped with Li, and silicon phases dispersed in the first silicon oxide phase, the second negative electrode active material includes a second silicon oxide phase doped with Mg, and silicon phases dispersed in the second silicon oxide phase, the negative electrode active material layer has a first surface facing the negative electrode current collector, and a second surface that is an opposite surface of the first surface, and given that a film thickness of the negative electrode active material layer is represented by T, a region of the negative electrode active material layer ranging in depth from the first surface to 0.5T is defined as a lower layer portion, and a region of the negative electrode active material layer ranging in depth from the second surface to 0.5T is defined as an upper layer portion, a content ratio Cb on a mass basis of the first negative electrode active material to a sum of the first negative electrode active material and the second negative electrode active material in the lower layer portion is larger than a content ratio Ct on a mass basis of the first negative electrode active material to a sum of the first negative electrode active material and the second negative electrode active material in the upper layer portion.

### Advantageous Effects of Invention

According to the present disclosure, a secondary battery having both high output characteristics and high capacity characteristics can be realized by using a silicon-containing material as a negative electrode active material.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a cross-sectional view of a negative electrode in a thickness direction thereof according to an embodiment of the present disclosure.

FIG. 2 is a longitudinal sectional view of a secondary battery according to an embodiment of the present disclosure.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be replaced with “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one type of them may be selected and used singly, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

In the following description, the word “comprise” or “include” is an expression including meanings of “comprise (or include)”, “essentially consist of”, and “consist of”.

Secondary batteries include at least nonaqueous electrolyte secondary batteries such as a lithium-ion battery and a lithium metal secondary battery.

A secondary battery according to an embodiment of the present disclosure includes a positive electrode, a negative electrode, and an electrolyte. The negative electrode includes a negative electrode current collector and a negative electrode active material layer provided on the negative electrode current collector. The negative electrode active material layer contains a first negative electrode active material and a second negative electrode active material.

The first negative electrode active material includes a first silicon oxide phase doped with Li and silicon phases dispersed in the first silicon oxide phase. Through Li doping, a portion of the silicon oxide phase can be changed to a lithium silicate phase. Thus, the first silicon oxide phase may include the lithium silicate phase (first lithium silicate phase). In this case, the silicon phases may be present and dispersed in the first lithium silicate phase.

The second negative electrode active material includes a second silicon oxide phase doped with Mg and silicon phases dispersed in the second silicon oxide phase. Through Mg doping, a portion of the silicon oxide phase can be changed to a magnesium silicate phase. Thus, the second silicon oxide phase may include the magnesium silicate phase (second magnesium silicate phase). In this case, the silicon phases may be present and dispersed in the second magnesium silicate phase.

The first silicon oxide phase may be doped with Li and doped also with Mg. In this case, the first silicon oxide phase may partially include a magnesium silicate phase (first magnesium silicate phase). Similarly, the second silicon oxide phase may be doped with Mg and doped also with Li. In this case, the second silicon oxide phase may partially include a lithium silicate phase (second lithium silicate phase). However, as will be described later, the amount of Li doped in the first silicon oxide phase is larger than the amount of Mg doped therein, and the amount of Mg doped in the second silicon oxide phase is larger than the amount of Li doped therein.

The negative electrode active material layer has a first surface facing the negative electrode current collector and a second surface serving as a surface opposite to the first surface. The second surface serves as a surface of the negative electrode. Given that the film thickness of the negative electrode active material layer is represented by T. When the negative electrode active material layer is divided into a lower layer portion in a region ranging in depth from the first surface to 0.5T and an upper layer portion in a region ranging in depth from the second surface to 0.5T, a content ratio Cb on a mass basis of the first negative electrode active material to the sum of the first negative electrode active material and the second negative electrode active material in the lower layer portion is larger than a content ratio Ct on a mass basis of the first negative electrode active material to the sum of the first negative electrode active material and the second negative electrode active material in the upper layer portion (Cb>Ct).

That is, the first negative electrode active material is contained more in the lower layer portion than in the upper layer portion, and the second negative electrode active material is contained more in the upper layer portion than in the lower layer portion. In other words, the concentrations of the first negative electrode active material and the second negative electrode active material have distributions in the thickness direction of the negative electrode active material layer. The concentration of the second negative electrode active material is large in the upper layer portion, while the concentration of the first negative electrode active material is large in the lower layer portion. Here, the concentration refers to a content ratio on a mass basis. The upper layer portion may be substantially free of the first negative electrode active material. The lower layer portion may be substantially free of the second negative electrode active material.

The second negative electrode active material, which is doped with Mg, is excellent in lithium ion conductivity. Therefore, as a result of the upper layer portion of the negative electrode active material layer containing a large amount of the second negative electrode active material, output characteristics such as rapid charge and discharge characteristics can be enhanced. On the other hand, as a result of the lower layer portion thereof containing a large amount of the Li-doped first negative electrode active material, the capacity per mass can be maintained high. By differentiating the concentrations of the first negative electrode active material and the second negative electrode active material between the upper layer portion and the lower layer portion, both high output characteristics and high capacity can be achieved.

The negative electrode active material layer may have a stacked structure in which at least a first layer and a second layer are stacked in the thickness direction. The first layer has a first surface facing the negative electrode current collector, and may be in contact with the negative electrode current collector. The second layer has a second surface on the side facing a surface of the negative electrode. In this case, a content ratio C1 on a mass basis of the first negative electrode active material to the sum of the first negative electrode active material and the second negative electrode active material in the first layer should be larger than a content ratio C2 on a mass basis of the first negative electrode active material to the sum of the first negative electrode active material and the second negative electrode active material in the second layer (C1>C2). Asa result of the first layer, which faces the negative electrode current collector, containing a large amount of the Li-doped first negative electrode active material, and the second layer, which faces the surface of the negative electrode, containing a large amount of the Mg-doped second negative electrode active material, the concentrations of the first negative electrode active material and the second negative electrode active material differ between the upper layer portion and the lower layer portion, thereby achieving both high output characteristics and high capacity.

The negative electrode active material layer may be composed of a plurality of layers. For example, in the negative electrode active material layer, one or more third layers may be provided between the first layer and the second layer. The content ratio on a mass basis of the first negative electrode active material to the sum of the first negative electrode active material and the second negative electrode active material may be different among the plurality of layers, and the content ratio may increase in the layers closer to the second surface (i.e., closer to the negative electrode current collector) relative to the other layers.

The boundary of the first layer on the side facing the second layer may not be at a depth of 0.5T from the first surface. The boundary of the second layer on the side facing the first layer may not beat a depth of 0.5T from the second surface. That is, the first layer may not coincide with the lower layer portion, and the second phase may not coincide with the upper layer portion. When the relationship (C1>C2) of the content ratio between the first layer and the second layer is satisfied, the relationship (Cb>Ct) of the content ratio between the lower layer portion and the upper layer portion is also satisfied.

In order to further improve the balance between the high output characteristics and high capacity, the thickness of the first layer may be 0.6T or more and 0.9T or less, and is more preferably 0.7T or more and 0.9T or less. The thickness of the second layer may be, for example, 0.1T or more and 0.4T or less, and is more preferably 0.1T or more and 0.3T or less.

For example, Li-doped SiOx represented by Liₐ₁Mg_{b1}SiOₓ₁ (where 0.1≤a1+b1≤6, 0<a1≤4, 0≤b1≤4, and 0.5≤x1≤1.6) can be used as the first negative electrode active material. The first negative electrode active material may be doped with Mg in addition to Li. Preferably, a1>b1 is satisfied.

For example, Mg-doped SiOx represented by Liₐ₂Mg_{b2}SiOₓ₂ (where 0.1≤a2+b2≤6, 0≤a2≤4, 0<b2≤4, and 0.5≤x2≤1.6) can be used as the second negative electrode active material. The second negative electrode active material may be doped with Li in addition to Mg. Preferably, a2<b2 is satisfied.

The amount of Mg doped in the first negative active material is smaller than the amount of Mg doped in the second negative active material, and b1<b2 is satisfied. It is possible that 0≤b1/b2<0.9, 0≤b1/b2<0.8, or 0≤b1/b2<0.7 is satisfied.

The amount of Li doped in the second negative electrode active material is smaller than the amount of Li doped in the first negative electrode active material, and a1>a2 is satisfied. It is possible that 0≤b1/b2<0.9, 0<b1/b2<0.8, or 0<b1/b2<0.7 is satisfied.

The main component (e.g., 95 to 100% by mass) of the first and second silicon oxide phases may be silicon dioxide. The first and second silicon oxide phases may be synthesized from a composite material containing silicon dioxide and silicon particles dispersed therein. The composition of the composite material containing silicon dioxide and the silicon particles dispersed therein can be expressed as SiOx as a whole. SiOx has a structure in which fine silicon particles are dispersed in an amorphous SiO₂ phase. The content ratio x of oxygen to silicon is, for example, 0.5≤x<2.0, and more preferably 0.8≤x≤1.5.

SiOx is synthesized using a gas phase method, for example. For example, when a Si powder and a SiO₂ powder are mixed and sublimated under reduced pressure, a composite material of a SiO₂ phase and fine Si phases (silicon particles) dispersed in the SiO₂ phase is obtained.

The first negative electrode active material may be obtained by synthesizing the first and second silicon oxide phases (lithium silicate phases) pre-doped with Li, and mixing while micronizing the lithium silicate phases and silicon particles for compounding. Similarly, the second negative electrode active material may be obtained by synthesizing the second silicon oxide phase (magnesium silicate) pre-doped with Mg, and mixing while micronizing the magnesium silicate and silicon particles for compounding.

However, SiOx particles synthesized using the gas phase method are formed through the synthesis such that the silicon phases are microscopically dispersed in the silicon dioxide phase in the particles. Therefore, the crystallite size of the silicon phases is very small, typically 10 nm or less (e.g., 6 nm). In addition, the SiOx particles are substantially free of impurities other than Li, Mg, Si, and O.

### (Doping Method)

The method of doping Li or Mg to SiOx is not particularly limited. For example, doping can be completed by mixing SiOx with lithium hydride, magnesium hydride, Li in a metal form and/or Mg in a metal form, at a temperature of 200° C. to 300° C., and then baking the resulting mixture at 600° C. to 800° C. in an inert atmosphere.

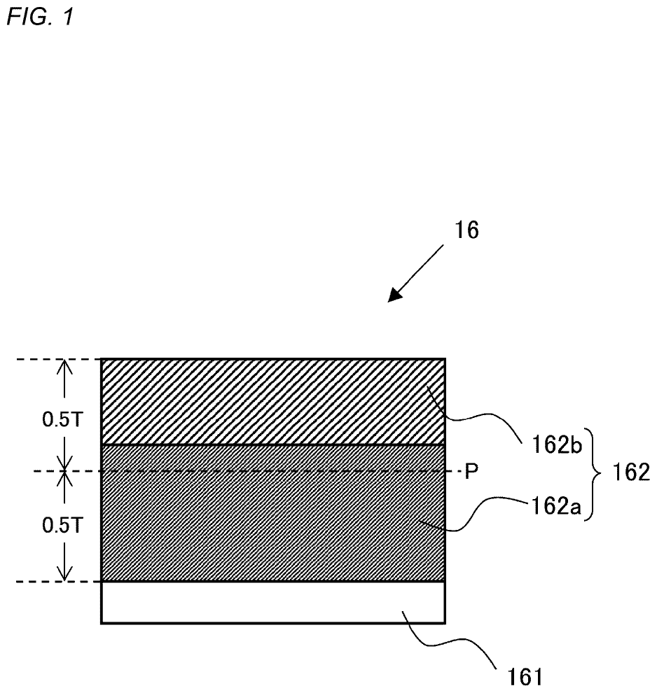

FIG. 1 is a schematic cross-sectional view of a structure of the negative electrode according to the present embodiment. A negative electrode 16 includes a negative electrode current collector 161 and negative electrode active material layers 162 (162a, 162b) formed on the negative electrode current collector 161. In the example illustrated in FIG. 1, the negative electrode active material layer 162 is formed on one of the surfaces of the negative electrode current collector 161, but the negative electrode active material layer 162 may be formed on both surfaces of the negative electrode current collector 161.

The negative electrode active material layer 162 is constituted by stacked layers of a lower layer mixture layer (first layer) 162a containing the first negative electrode active material and an upper layer mixture layer 162b (second layer) containing the second negative electrode active material. The lower layer mixture layer 162a faces and contacts the negative electrode current collector 161, and the outer surface of the upper layer mixture layer 162b constitutes the outer surface of the negative electrode active material layer 162.

The film thicknesses of the lower layer mixture layer 162a and the upper layer mixture layer 162b may not be the same. That is, given that the total thickness of the negative electrode active material layer 162 is represented by T, the boundary between the lower layer mixture layer 162a and the upper layer mixture layer 162b of the negative electrode active material layer 162 may be located closer to the negative electrode current collector than a position P at a depth of 0.5T from the outer surface of the negative electrode active material layer (a depth of 0.5T from the contacting surface of the negative electrode active material layer with the negative electrode current collector), or may be located closer to the outer surface. However, in any of the cases, when a region closer to the negative electrode current collector than the position P is referred to as the lower layer portion (which includes the lower layer mixture layer 162a and may include the upper layer mixture layer 162b), and a region closer to the outer surface than the position P is referred to as the upper layer portion (which includes the upper layer mixture layer 162b and may include the lower layer mixture layer 162a), the content ratio Cb on a mass basis of the first negative electrode active material to the sum of the first negative electrode active material and the second negative electrode active material in the lower layer portion is larger than the content ratio Ct on a mass basis of the first negative electrode active material to the sum of the first negative electrode active material and the second negative electrode active material in the upper layer portion (Cb>Ct).

Another layer may be provided as a third layer between the lower layer mixture layer (first layer) 162a and the upper layer mixture layer 162b (second layer). In this case, the content ratio on a mass basis of the first negative electrode active material in the third layer is between the content ratio on a mass basis of the first negative electrode active material in the first layer and the content ratio on a mass basis of the first negative electrode active material in the second layer. The content ratio on a mass basis of the second negative electrode active material in the third layer is between the content ratio on a mass basis of the second negative electrode active material in the first layer and the content ratio on a mass basis of the second negative electrode active material in the second layer.

The negative electrode 16 can be produced by preparing a plurality of negative electrode slurries having different content ratios of the second negative electrode active material to the first negative electrode active material and applying the negative electrode slurries onto the surface of the negative electrode current collector 161.

Next, a secondary battery according to an embodiment of the present disclosure will be described in detail. The secondary battery includes the following positive electrode, negative electrode, electrolyte (nonaqueous electrolyte), and separator, for example.

### [Positive Electrode]

The positive electrode includes a positive electrode current collector and a positive electrode active material layer provided on a surface of the positive electrode current collector. The positive electrode current collector is constituted by a sheet-like conductive material. The positive electrode active material layer is supported on either or both surfaces of the positive electrode current collector. The positive electrode active material layer is typically a layer or a film constituted by a positive electrode mixture. The thickness of the positive electrode active material layer is, for example, 10 μm to 150 μm per one side of the positive electrode current collector. The positive electrode mixture contains a positive electrode active material as an essential component.

The positive electrode mixture may contain a conductive agent as an optional component. Examples of the conductive agent include carbon-based materials such as carbon black (CB), acetylene black (AB), Ketjen black, carbon nanotubes (CNT), graphene, and graphite. Any of these may be used singly or in a combination of two or more.

The positive electrode mixture may contain a binder. Examples of the binder include fluorocarbon-based resins such as polytetrafluoroethylene (PTFE) and polyvinylidene fluoride (PVDF), polyacrylonitrile (PAN), polyimide-based resins, acrylic resins, and polyolefin-based resins. Any of these may be used singly or in a combination of two or more.

As the positive electrode current collector, a non-porous conductive substrate (e.g., a metal foil) or a porous conductive substrate (e.g., a mesh body, a net body, or a punching sheet) is used. Examples of the material of the positive electrode current collector include aluminum, an aluminum alloy, titanium, and a titanium alloy.

As the positive electrode active material, a lithium-containing composite oxide can be used. The lithium-containing composite oxide may have a layered rock salt structure. The layered rock salt structure may belong to the space group R-3m or the space group C2/m, for example. Among them, a layered rock salt structure belonging to the space group R-3m is preferable in terms of high capacity and highly stable crystalline structure. The layered rock salt of the lithium-containing composite oxide may include any of a transition metal layer, a Li layer, and an oxygen layer.

In view of increasing capacity, the rate of Ni (Ni content percentage) in metal elements contained in the lithium-containing composite oxide other than Li may be 50 at. % or more, may be 80 at. % or more, or may be 90 at. % or more.

In view of stabilizing the crystalline structure of the lithium-containing composite oxide and increasing the heat resistance of the battery, the rate of Co (Co content percentage) in the metal elements contained in the lithium-containing composite oxide other than Li may be 0 at. % or more and 16 at. % or less, or may be 1.5 at. % or more and 16 at. % or less.

Similarly, in view of stabilizing the crystalline structure of the lithium-containing composite oxide and increasing the heat resistance of the battery, the rate of Al (Al content percentage) in the metal elements contained in the lithium-containing composite oxide other than Li may be 0 at. % or more and 18.5 at. % or less, or may be 4 at. % or more and 10 at. % or less.

In view of cost reduction, the rate of Mn (Mn content percentage) in the metal elements contained in the lithium-containing composite oxide other than Li may be 0 at. % or more and 50 at. % or less, or may be 0 at. % or more and 30 at. % or less.

The content percentage of each metal element contained in the lithium-containing composite oxide is measured by inductively coupled plasma (ICP) optical emission spectroscopy, for example.

The lithium-containing composite oxide may be, for example, a composite oxide represented by general formula LiₐNiₓCo_{y}Al_{z}M1_{w}O_{2-b} (where in the formula, 0.8≤a≤1.2, 0.80≤x≤0.95, 0.015≤y≤0.16, 0.04≤z≤0.185, 0≤w≤0.145, 0≤b<0.05, x+y+z+w=1, and M1 is at least one element selected from Mn, Fe, Ti, Si, Nb, Zr, Mo, and Zn). In this case, M1 is preferably Mn.

### [Negative Electrode]

The negative electrode includes a negative electrode current collector and a negative electrode active material layer provided on a surface of the negative electrode current collector, for example. The negative electrode current collector is constituted by a sheet-like conductive material. A negative electrode mixture layer is supported on either or both surfaces of the negative electrode current collector. The negative electrode mixture layer is usually a layer or a film constituted by a negative electrode mixture. The thickness of the negative electrode mixture layer is, for example, 10 μm to 150 μm per one side of the negative electrode current collector. The negative electrode mixture contains a negative electrode active material as an essential component. The negative electrode active material layer in the present disclosure contains a first negative electrode active material and a second negative electrode active material. When the negative electrode active material layer is divided into a lower layer portion and an upper layer portion as described above, the content ratio Cb on a mass basis of the first negative electrode active material to the sum of the first negative electrode active material and the second negative electrode active material in the lower layer portion is set larger than the content ratio Ct on a mass basis of the first negative electrode active material to the sum of the first negative electrode active material and the second negative electrode active material in the upper layer portion.

The negative electrode active material layer may include, for example, a first layer containing at least the first negative electrode active material and a second layer containing at least the second negative electrode active material. The first layer and the second layer can be formed, for example, by sequentially applying negative electrode slurries of negative electrode mixtures, with the first active material and the second active material dispersed in dispersion media, onto the surface of the negative electrode current collector, and drying the negative electrode slurries. The content ratio on a mass basis of the first negative electrode active material to the second negative electrode active material in the negative electrode slurry for forming the first layer is different from that in the negative electrode slurry for forming the second layer. The dried coating films may be rolled as necessary. The negative electrode active material layer may be formed on either or both surfaces of the negative electrode current collector.

The negative electrode mixture contains a negative electrode active material as an essential component, and may contain, for example, a binder, a conductive agent, and a thickener as optional components. Known materials can be used as the binder, the conductive agent, and the thickener.

The negative electrode active material may further contain another material that electrochemically absorbs and releases lithium ions. The material used in combination with the first and second negative electrode active materials is preferably a carbon material. Examples of the carbon material include graphite, graphitizable carbon (soft carbon), and non-graphitizable carbon (hard carbon). Among them, graphite, which has excellent charge and discharge stability and low irreversible capacity loss, is preferable.

By using the first and second negative electrode active materials and the carbon material in combination as the negative electrode active material, excellent cycle characteristics can be achieved while imparting high output and high capacity to the negative electrode.

The total content ratio of the first and second negative electrode active materials to the total of the first and second negative electrode active materials and the carbon material is preferably, for example, 0.5 to 15% by mass, and more preferably 1 to 10% by mass. This can facilitate achievement of both higher capacity and improved cycle characteristics.

As the negative electrode current collector, a non-porous conductive substrate (e.g., a metal foil) or a porous conductive substrate (e.g., a mesh body, a net body, or a punching sheet) is used. Examples of the material of the negative electrode current collector include stainless steel, nickel, a nickel alloy, copper, and a copper alloy.

### [Nonaqueous Electrolyte]

The nonaqueous electrolyte contains a nonaqueous solvent and a solute dissolved in the nonaqueous solvent. The solute contains a lithium salt, for example. The component of the nonaqueous electrolyte other than the nonaqueous solvent and the solute is an additive. The nonaqueous electrolyte contains the aforementioned sulfur-containing compound as the additive.

Examples of the nonaqueous solvent include cyclic carbonic acid esters, chain carbonic acid esters, cyclic carboxylic acid esters, and chain carboxylic acid esters. Examples of the cyclic carbonic acid esters include propylene carbonate (PC), ethylene carbonate (EC), and vinylene carbonate (VC). Examples of the chain carbonic acid esters include diethyl carbonate (DEC), ethyl methyl carbonate (EMC), and dimethyl carbonate (DMC). Examples of the cyclic carboxylic acid esters include γ-butyrolactone (GBL) and γ-valerolactone (GVL). Examples of the chain carboxylic acid esters include methyl acetate, ethyl acetate, propyl acetate, methyl propionate (MP), and ethyl propionate (EP). One type of nonaqueous solvent may be used singly, or two or more types thereof may be used in combination.

Examples of the lithium salt that can be used include lithium salts of chlorine-containing acids (e.g., LiClO₄, LiAlCl₄, and LiB₁₀Cl₁₀), lithium salts of fluorine-containing acids (e.g., LiPF₆, LiPF₂O₂, LiBF₄, LiSbF₆, LiAsF₆, LiCF₃SO₃, and LiCF₃CO₂), lithium salts of fluorine-containing acid imides (e.g., LiN(FSO₂)₂, LiN(CF₃SO₂)₂, LiN(CF₃SO₂)(C₄F₉SO₂), and LiN(C₂F₅SO₂)₂), and lithium halides (e.g., LiCl, LiBr, and LiI). One type of the lithium salt may be used singly, or two or more types thereof may be used in combination.

The concentration of the lithium salt in the nonaqueous electrolyte may be 1 mol/liter or more and 2 mol/liter or less, or may be 1 mol/liter or more and 1.5 mol/liter or less. By controlling the lithium salt concentration within the above range, an electrolyte having excellent ion conductivity and an appropriate viscosity can be obtained. However, the lithium salt concentration is not limited to the above.

### [Separator]

The separator is preferably provided between the positive electrode and the negative electrode. The separator has high ion permeability and moderate mechanical strength and insulating properties. As the separator, a microporous thin film, a woven fabric, or a nonwoven fabric can be used, for example. The material of the separator is preferably a polyolefin such as polypropylene or polyethylene.

One example of the structure of the secondary battery is a structure in which an electrode group in which a positive electrode and a negative electrode are wound with a separator therebetween, and a nonaqueous electrolyte are housed in an outer body. Alternatively, instead of the wound-type electrode group, another type of electrode group, such as a stacked-type electrode group in which a positive electrode and a negative electrode are stacked via a separator, may be adopted. The secondary battery may come in various types, including cylindrical, prismatic, coin-shaped, button-shaped, and pouch types.

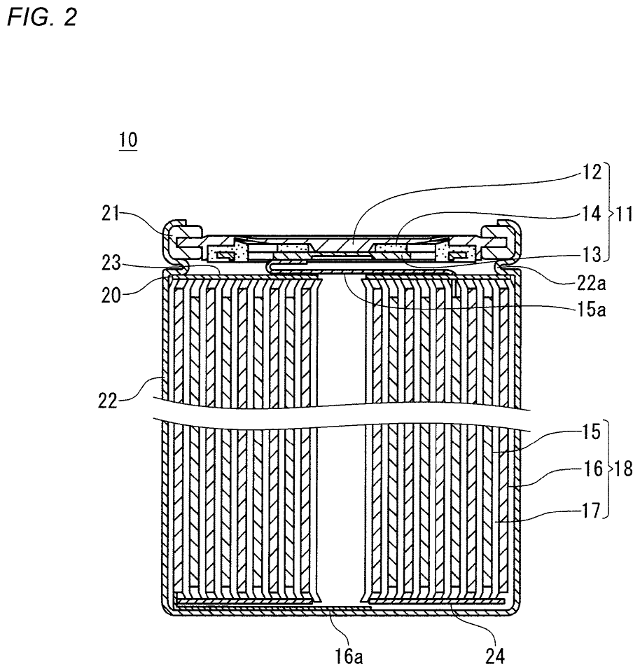

FIG. 2 is a schematic longitudinal sectional view of a cylindrical secondary battery according to an embodiment of the present disclosure. A cylindrical secondary battery (hereinafter, referred to as a battery) 10 includes an electrode group 18, a nonaqueous electrolyte (not illustrated), and a battery case (battery can) 22 that houses these. The electrode group 18 includes a positive electrode plate 15 and a negative electrode plate 16 wound with a separator 17 therebetween. An annular groove 22a is formed in the vicinity of the open end of the battery can 22.

The opening of the battery can 22 is sealed by a sealing body 11 with a gasket 21 around its periphery. The sealing body 11 includes a valve body 12, a metal plate 13, and an annular insulating member 14 provided between the outer periphery of the valve body 12 and the outer periphery of the metal plate 13. The valve body 12 and the metal plate 13 are connected to each other at their central parts. A positive electrode lead 15a led out from the positive electrode 15 is connected to the metal plate 13. In the above configuration, the valve body 12 functions as an external terminal of the positive electrode. A negative electrode lead 16a led out from the negative electrode 16 is connected (welded) to the inner bottom surface of the battery can 22. A first insulating plate 24 is provided between one end surface of the electrode group 18 and the bottom of the battery can 22. A second insulating plate 23 is provided between the sealing body 11 and the other end surface of the electrode group 18.

The secondary battery may be of, for example, cylindrical, coin-shaped, or button-shaped type including a metal battery case, or may be a pouch battery including a battery case constituted by a laminate sheet that is a laminate of a barrier layer and a resin sheet. In the present disclosure, no specific limitations are placed on, for example, the type and shape of the secondary battery.

### <Supplemental Notes>

According to the above description of the embodiment, the following techniques are disclosed.

### (Technique 1)

A secondary battery including a positive electrode, a negative electrode; and an electrolyte, wherein
the negative electrode includes a negative electrode current collector and a negative electrode active material layer provided on the negative electrode current collector,
the negative electrode active material layer contains a first negative electrode active material and a second negative electrode active material,
the first negative electrode active material includes a first silicon oxide phase doped with Li, and silicon phases dispersed in the first silicon oxide phase,
the second negative electrode active material includes a second silicon oxide phase doped with Mg, and silicon phases dispersed in the second silicon oxide phase,
the negative electrode active material layer has a first surface facing the negative electrode current collector, and a second surface that is an opposite surface of the first surface, and
given that a film thickness of the negative electrode active material layer is represented by T, a region of the negative electrode active material layer ranging in depth from the first surface to 0.5T is defined as a lower layer portion, and a region of the negative electrode active material layer ranging in depth from the second surface to 0.5T is defined as an upper layer portion, a content ratio Cb on a mass basis of the first negative electrode active material to a sum of the first negative electrode active material and the second negative electrode active material in the lower layer portion is larger than a content ratio Ct on a mass basis of the first negative electrode active material to a sum of the first negative electrode active material and the second negative electrode active material in the upper layer portion.

### (Technique 2)

The secondary battery according to Technique 1, wherein
the negative electrode active material layer includes a first layer having the first surface, and a second layer having the second surface, and
a content ratio C1 on a mass basis of the first negative electrode active material to a sum of the first negative electrode active material and the second negative electrode active material in the first layer is larger than a content ratio C2 on a mass basis of the first negative electrode active material to a sum of the first negative electrode active material and the second negative electrode active material in the second layer.

### (Technique 3)

The secondary battery according to Technique 2, wherein
the negative electrode active material layer includes a plurality of layers,
the layers have different content ratios on a mass basis of the first negative electrode active material to a sum of the first negative electrode active material and the second negative electrode active material, and
among the content ratios, a content ratio of a layer closer to the second surface is smaller.

### (Technique 4)

The secondary battery according to Technique 2 or 3, wherein
a thickness of the first layer is 0.6T or more and 0.9T or less, and
a thickness of the second layer is 0.1T or more and 0.4T or less.

### (Technique 5)

The secondary cell according to any one of Techniques 1 to 4, wherein
the first negative electrode active material is represented by Liₐ₁Mg_{b1}SiOₓ₁ (where 0.1≤a1+b1≤6, 0<a1≤4, 0≤b1≤4, and 0.5≤x1≤1.6),
the second negative electrode active material is represented by Liₐ₂Mg_{b2}SiOₓ₂ (where 0.1≤a2+b2≤6, 0≤a2≤4, 0<b2≤4, and 0.5≤x2≤1.6), and
a1>a2 and b1<b2 are satisfied.

Hereinafter, the present disclosure will be described in detail based on examples and comparative examples, but the present disclosure is not limited to the following examples.

### Example 1

### [First Negative Electrode Active Material Synthesis]

A Si powder and a SiO₂ powder in a molar ratio of 1:1 was mixed and sublimated at 1300° C. under reduced pressure to prepare SiO. The prepared SiO was crushed using a jet mill so as to have a mean particle diameter (D50) of 6 μm, thereby obtaining a SiO powder. Thereafter, the SiO powder was subjected to carbon coating (C coating) at 850° C. by thermal CVD with a mixed gas of argon and propane as a carbon source. Lithium hydride was mixed with the C-coated SiO powder so that the molar ratio to SiO was LiH:SiO=0.1:1, and the resulting mixture was then baked at 700° C. for 10 hours to obtain Li-doped SiO (Li—SiO) as a first negative electrode active material.

### [Second Negative Electrode Active Material Synthesis]

Magnesium hydride was mixed with a C-coated SiO powder synthesized in the same manner as that described above so that the molar ratio to SiO was MgH₂:SiO=0.1:1. The resulting mixture was then baked at 700° C. for 10 hours to obtain Mg-doped SiO (Mg—SiO) as a second negative electrode active material.

### [Negative Electrode Preparation]

First, 90 parts by mass of a graphite powder as a negative electrode active material, 10 parts by mass of the first negative electrode active material, 0.8 parts by mass of carboxymethylcellulose (CMC), 0.1 parts by mass of carbon nanotube (CNT), and water were mixed. The resulting mixture was mixed with 1.2 parts by mass of styrene-butadiene rubber (SBR) and water to prepare a first negative electrode mixture slurry.

Furthermore, 90 parts by mass of a graphite powder as a negative electrode active material, 10 parts by mass of the second negative electrode active material, 0.8 parts by mass of carboxymethylcellulose (CMC), 0.1 parts by mass of carbon nanotube (CNT), and water were mixed. The resulting mixture was mixed with 1.2 parts by mass of styrene-butadiene rubber (SBR) and water to prepare a second negative electrode mixture slurry.

The first negative electrode mixture slurry was applied onto the surfaces of the copper foil serving as a negative electrode current collector. The resulting coating film was dried. Thereafter, the second negative electrode mixture slurry was further applied, and the resulting coating film was dried. In doing so, the coating amounts were controlled so that the relative thickness of the negative electrode mixture layer (second layer) formed by drying the second negative electrode mixture slurry became 1 when the thickness of the negative electrode mixture layer (first layer) formed by drying the first negative electrode mixture slurry was set to 9. A negative electrode, which includes negative electrode active material layers formed on both surfaces of the negative electrode current collector, was produced by compressing each coating film to a specific thickness using a rolling roller.

### [Positive Electrode Preparation]

LiNi_{0.8}Co_{0.15}Al_{0.05}O₂ (NCA) as a positive electrode active material, acetylene black (AB), and polyvinylidene fluoride (PVDF) were mixed in a mass ratio of 94:5:1, and an appropriate amount of N-methyl-2-pyrrolidone (NMP) was further added to prepare a positive electrode mixture slurry. Next, the positive electrode mixture slurry was applied onto both surfaces of a positive electrode current collector made from an aluminum foil, and then the resulting coating film was dried to form positive electrode mixture layers. Each coating film was compressed to a specific thickness using a rolling roller to produce a positive electrode including positive electrode active material layers formed on the respective surfaces of the positive electrode current collector.

### [Electrolytic Solution Preparation]

An electrolyte solution was prepared by adding LiPF₆ as a lithium salt to a mixed solvent containing ethylene carbonate (EC), ethyl methyl carbonate (EMC), and dimethyl carbonate (DMC) in a volume ratio of 3:3:4. The concentration of LiPF₆ in the nonaqueous electrolyte was set to 1.2 mol/liter.

### [Secondary Battery Production]

The positive electrode and the negative electrode were wound around a winding core having a radius of curvature of 1.5 mm with a separator with a thickness of 20 μm made from a polyethylene microporous film therebetween, and tape was adhered to its outermost peripheral surface to produce a cylindrical wound-type electrode assembly. A positive electrode lead made of aluminum was welded to a current collector exposed part of the positive electrode, and a negative electrode lead made of nickel was welded to a current collector exposed part of the negative electrode.

The resulting electrode body was housed in a bottomed cylindrical outer can. The positive electrode lead was welded to a sealing body, and the negative electrode lead was welded to the inner bottom surface of the outer can. After injecting the nonaqueous electrolyte into the outer can, the opening of the outer can was sealed with the sealing body to produce a nonaqueous electrolyte secondary battery (height 65 mm, diameter 18 mm), thereby obtaining a battery A1 for evaluation.

### Example 2

In the negative electrode preparation, the coating amounts of the first and second negative electrode mixture slurries were controlled so that the relative thickness of the negative electrode mixture layer (the second layer) formed by drying the second negative electrode mixture slurry became 4 when the thickness of the negative electrode mixture layer (the first layer) formed by drying the first negative electrode mixture slurry was set to 6. Except the above, a nonaqueous electrolyte secondary battery was produced in the same manner as in Example 1 to obtain a battery A2.

### Comparative Example 1

In the negative electrode preparation, the second negative electrode mixture slurry was applied twice with the same thickness and then dried to form a negative electrode mixture layer. Except the above, a nonaqueous electrolyte secondary battery was produced in the same manner as in Example 1 to obtain a battery B1.

### Comparative Example 2

In the negative electrode preparation, the first negative electrode mixture slurry was applied twice with the same thickness and then dried to form a negative electrode mixture layer. Except the above, a nonaqueous electrolyte secondary battery was produced in the same manner as in Example 1 to obtain a battery B2.

### Comparative Example 3

In the negative electrode preparation, 90 parts by mass of a graphite powder as a negative electrode active material, 5 parts by mass of the first negative electrode active material, 5 parts by mass of the second negative electrode active material, 0.8 parts by mass of carboxymethylcellulose (CMC), 0.1 parts by mass of carbon nanotubes (CNT), and water were mixed. The resulting mixture was mixed with 1.2 parts by mass of styrene-butadiene rubber (SBR) and water to prepare a third negative electrode mixture slurry.

The third negative electrode mixture slurry was applied twice with the same thickness and then dried to form a negative electrode mixture layer. Except the above, a nonaqueous electrolyte secondary battery was produced in the same manner as in Example 1 to obtain a battery B3.

### Comparative Example 4

In the negative electrode preparation, the second negative electrode mixture slurry was applied onto a surface of the copper foil serving as a negative electrode current collector, and the resulting coating film was dried. Further, the first negative electrode mixture slurry was applied, and the resulting coating film was dried. In doing so, the coating amounts were controlled so that the relative thickness of the negative electrode mixture layer (second layer) formed by drying the first negative electrode mixture slurry became 4 when the thickness of the negative electrode mixture layer (first layer) formed by drying the second negative electrode mixture slurry was set 6. Except the above, a nonaqueous electrolyte secondary battery was produced in the same manner as in Example 1 to obtain a battery B4.

### [Evaluation]

### (High-Rate Charge and Discharge Characteristics)

The finished batteries were placed in an environment at 25° C., charged at a constant current of 0.7 C until the voltage became 4.1 V, and then charged at constant voltage of 4.1V until the current became 0.5 C. Thereafter, constant current discharge at a current of 3 C was performed until the voltage became 2.75 V. This cycle of charge and discharge was repeated for a total of 400 cycles. The charge and discharge were performed in an environment at 25° C.

The percentage of a discharge capacity C₄₀₀ at the 400-th cycle to a discharge capacity C₁ at the first cycle was regarded as a capacity retention rate R (%) at a high rate, and the capacity retention rate R (=C₄₀₀/C₁×100) was evaluated.

Table 1 shows the initial capacity C₁ at the first cycle and the capacity retention rate R as an evaluation result of each of the batteries A1, A2, and B1 to B4. Table 1 also shows the negative electrode active material contained in the negative electrode active material layer of the negative electrode used in each battery and the thickness thereof. In Table 1, the first layer refers to a layer (lower layer) of the negative electrode active material layer in contact with the negative electrode current collector. The second layer refers to a layer (upper layer) of the negative electrode active material layer that serves as the surface of the negative electrode. All the batteries had the same total thickness of the first layer and the second layer.

As shown in Table 1, when the first layer of the negative electrode active material layer faced the negative electrode current collector and the second layer thereof served as the surface of the negative electrode, the batteries A1 and A2, in which the first layer contained Li—SiO as the first negative electrode active material while the second layer contained Mg—SiO as the second negative electrode active material, had a large capacity and maintained a high high-rate capacity retention rate.

The battery B1, which used Mg—SiO, had an excellent high-rate capacity retention rate, but had a small capacity per mass. By contrast, the battery B2, which used Li—SiO, had a large capacity per mass, but significantly reduced the high-rate capacity retention rate.

The battery B3 used Li—SiO as the first negative electrode active material and Mg—SiO as the second negative electrode active material. However, due to uniform distribution of these in the negative electrode active material layer, a decrease in the high-rate capacity retention rate was not suppressed.

Similarly, in the battery B4 in which the first layer contains Mg—SiO as the second negative electrode active material and the second layer contains Li—SiO as the first negative electrode active material, a decrease in the high-rate capacity retention rate was not suppressed.

TABLE 1

| | | | | Discharge | High-rate |
|---|---|---|---|---|---|
| | Negative electrode active material layer | | | capacity | capacity |
| | First layer | Second layer | Thickness ratio | C₁ at 1^{st} | retention |
| Battery | (lower layer) | (upper layer) | (1^{st} layer:2^{nd} layer) | cycle (mAh) | rate |
| A1 | Li—SiO | Mg—SiO | 9:1 | 3340 | 83 |
| A2 | Li—SiO | Mg—SiO | 6:4 | 3332 | 84 |
| B1 | Mg—SiO | Mg—SiO | 5:5 | 3302 | 85 |
| B2 | Li—SiO | Li—SiO | 5:5 | 3353 | 75 |
| B3 | Li—SiO | Li—SiO | 5:5 | 3327 | 76 |
| | Mg—SiO | Mg—SiO | | | |
| B4 | Mg—SiO | Li—SiO | 6:4 | 3322 | 74 |

### INDUSTRIAL APPLICABILITY

According to the secondary battery of the present disclosure, it is possible to provide a nonaqueous electrolyte secondary battery having a high capacity and excellent cycle characteristics. The secondary battery according to the present disclosure is useful as a main power supply of a mobile communication device or a portable electronic device, for example.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

10: nonaqueous electrolyte secondary battery, 11: sealing body, 12: valve body, 13: metal plate, 14: insulating member, 15: positive electrode, 15a: positive electrode lead, 16: negative electrode, 16a: negative electrode lead, 17: separator, 18: electrode group, 21: gasket, 22: battery can, 22a: annular groove, 23: second insulating plate, 24: first insulating plate, 161: negative electrode current collector, 162: negative electrode active material layer, 162a: lower layer mixture layer, 162b: upper layer mixture layer

1. A secondary battery comprising:
a positive electrode;
a negative electrode; and
an electrolyte, wherein
the negative electrode includes a negative electrode current collector and a negative electrode active material layer provided on the negative electrode current collector,
the negative electrode active material layer contains a first negative electrode active material and a second negative electrode active material,
the first negative electrode active material includes a first silicon oxide phase doped with Li, and silicon phases dispersed in the first silicon oxide phase,
the second negative electrode active material includes a second silicon oxide phase doped with Mg, and silicon phases dispersed in the second silicon oxide phase,
the negative electrode active material layer has a first surface facing the negative electrode current collector, and a second surface that is an opposite surface of the first surface, and
given that a film thickness of the negative electrode active material layer is represented by T, a region of the negative electrode active material layer ranging in depth from the first surface to 0.5T is defined as a lower layer portion, and a region of the negative electrode active material layer ranging in depth from the second surface to 0.5T is defined as an upper layer portion, a content ratio Cb on a mass basis of the first negative electrode active material to a sum of the first negative electrode active material and the second negative electrode active material in the lower layer portion is larger than a content ratio Ct on a mass basis of the first negative electrode active material to a sum of the first negative electrode active material and the second negative electrode active material in the upper layer portion.

2. The secondary battery according to claim 1, wherein
the negative electrode active material layer includes a first layer having the first surface, and a second layer having the second surface, and
a content ratio C1 on a mass basis of the first negative electrode active material to a sum of the first negative electrode active material and the second negative electrode active material in the first layer is larger than a content ratio C2 on a mass basis of the first negative electrode active material to a sum of the first negative electrode active material and the second negative electrode active material in the second layer.

3. The secondary battery according to claim 2, wherein
the negative electrode active material layer includes a plurality of layers,
the layers have different content ratios on a mass basis of the first negative electrode active material to a sum of the first negative electrode active material and the second negative electrode active material, and
among the content ratios, a content ratio of a layer closer to the second surface is smaller.

4. The secondary battery according to claim 2, wherein
a thickness of the first layer is 0.6T or more and 0.9T or less, and
a thickness of the second layer is 0.1T or more and 0.4T or less.

5. The secondary battery according to claim 1, wherein
the first negative electrode active material is represented by Liₐ₁Mg_{b1}SiOₓ₁ (where 0.1≤a1+b1≤6, 0<a1≤4, 0≤b1≤4, and 0.5≤x1≤1.6),
the second negative electrode active material is represented by Liₐ₂Mg_{b2}SiOₓ₂ (where 0.1≤a2+b2≤6, 0≤a2≤4, 0<b2≤4, and 0.5≤x2≤1.6), and
a1>a2 and b1<b2 are satisfied.
